(19) United States
(12) Patent Application Publication
(10) Pub. No.: US 2026/0080683 A1
(43) Pub. Date: Mar. 19, 2026

(54) MANAGEMENT METHOD, MANAGEMENT DEVICE AND RECORDING MEDIUM

(71) Applicant: NEC Corporation, Tokyo (JP)

(72) Inventors: Satoshi HIRATA, Tokyo (JP); Hajime YAMASHITA, Tokyo (JP); Genki YAMAMOTO, Tokyo (JP); Masafumi SHIBATA, Tokyo (JP); Dai HASHIMOTO, Tokyo (JP); Takahiro KIMOTO, Tokyo (JP); Youhei TAKAHASHI, Tokyo (JP)

(73) Assignee: NEC Corporation, Tokyo (JP)

(21) Appl. No.: 19/401,487

(22) Filed: Nov. 26, 2025

Related U.S. Application Data
(63) Continuation of application No. 17/909,540.

(51) Int. Cl. G06V 20/40; G06V 10/74

(52) U.S. Cl. CPC G06V 20/44; G06V 10/761

(57) ABSTRACT

A management method, a computer performs an acquisition of video data from a monitoring terminal, an acquisition of a first event and a detection time of the first event from the video data; and a display of the detection time of the first event and an icon corresponding to a type of the first event, in a form according to the importance of the first event, on a display devise.

This application is a continuation application of U.S. patent application Ser. No. 17/909,540 filed on Sep. 6, 2022, which is a National Stage Entry of PCT/JP2020/014892 filed on Mar. 31, 2020, the contents of all of which are incorporated herein by reference, in their entirety.

### TECHNICAL FIELD

The present invention relates to a management method and the like that displays, on a screen, information on an event detected in video data.

### BACKGROUND ART

In monitoring with a general monitoring camera, a monitoring staff checks videos taken by a plurality of monitoring cameras disposed on a street and detects an event such as a crime or an accident on the street. In such monitoring, a situation occurs in which a single monitoring staff is forced to support multiple events detected at multiple places. In such a situation, if the confirmation of the events is delayed, the event to be supported urgently is postponed, which may lead to an irreversible situation. Therefore, it is needed to efficiently confirm the occurred events.

PTL 1 discloses an image monitoring device that supplies information for image monitoring to a monitoring terminal. The device of PTL 1 records a moving image of a monitoring area captured by a monitoring camera as image information including a still image of a predetermined frame in association with the monitoring camera and a capturing time. The device of PTL 1 performs image analysis on a moving image to extract a plurality of predetermined types of events and stores the extracted event information in association with the monitoring camera and the capturing time for each type. The device of PTL 1 associates event information extracted from a moving image with the image information and provides the information to a monitoring terminal.

### CITATION LIST

### Patent Literature

[PTL 1] JP 2007-243342 A

### SUMMARY OF INVENTION

### Technical Problem

According to the method of PTL 1, since the image information is displayed on the screen of the monitoring terminal in association with the event information, it is easy to confirm what kind of event has occurred at which position on the image that the event has been extracted. However, in the method of PTL 1, it is easy to confirm an event whose situation has already been determined, but it is not easy to confirm an event whose situation has not yet been determined.

An object of the present invention is to provide a management method and the like that enable efficient confirmation of an event detected in video data.

### Solution to Problem

A management method according to an aspect of the present invention, a computer performs an acquisition of video data from a monitoring terminal, an acquisition of a first event and a detection time of the first event from the video data; and a display of the detection time of the first event and an icon corresponding to a type of the first event, in a form according to the importance of the first event, on a display devise.

A management device according to an aspect of the present invention that acquires video data from a monitoring terminal, acquires a first event and a detection time of the first event from the video data, and displays the detection time of the first event and an icon corresponding to a type of the first event, in a form according to the importance of the first event, on a display devise.

A program according to an aspect of the present invention causes a computer to execute processing of extracting a processing of acquiring video data from a monitoring terminal, a processing of acquiring a first event and a detection time of the first event from the video data, and a processing of displaying the detection time of the first event and an icon corresponding to a type of the first event, in a form according to the importance of the first event, on a display devise.

### Advantageous Effects of Invention

According to the present invention, it is possible to provide a management device and the like that enable efficient confirmation of an event detected in video data.

### BRIEF DESCRIPTION OF DRAWINGS

FIG. 1 is a block diagram illustrating an example of a configuration of a monitoring system according to a first example embodiment.

FIG. 2 is a block diagram illustrating an example of a configuration of a management device according to the first example embodiment.

FIG. 3 is a conceptual diagram illustrating an example of display information displayed on a screen of a management terminal included in the monitoring system according to the first example embodiment.

FIG. 4 is a conceptual diagram illustrating another example of the display information displayed on the screen of the management terminal included in the monitoring system according to the first example embodiment.

FIG. 5 is a block diagram illustrating an example of a configuration of a monitoring terminal and a monitoring data recording device included in the monitoring system according to the first example embodiment.

FIG. 6 is a block diagram illustrating an example of a configuration of a monitoring data recording device and other devices included in the monitoring system according to the first example embodiment.

FIG. 7 is a block diagram illustrating an example of a configuration of the management device and other devices included in the monitoring system according to the first example embodiment.

FIG. 8 is a block diagram illustrating an example of a configuration of a video analysis device and other devices included in the monitoring system according to the first example embodiment.

FIG. 9 is a block diagram illustrating an example of a configuration of the management terminal and other devices included in the monitoring system according to the first example embodiment.

FIG. 10 is a conceptual diagram for describing a display example of a display unit of the management terminal included in the monitoring system according to the first example embodiment.

FIG. 11 is a conceptual diagram illustrating another display example of the display unit of the management terminal included in the monitoring system according to the first example embodiment.

FIG. 12 is a conceptual diagram for describing still another display example of the display unit of the management terminal included in the monitoring system according to the first example embodiment.

FIG. 13 is a conceptual diagram illustrating an example of a window displayed on the display unit of the management terminal included in the monitoring system according to the first example embodiment.

FIG. 14 is a flowchart for explaining an example of an operation of the monitoring terminal included in the monitoring system according to the first example embodiment.

FIG. 15 is a flowchart for explaining an example of an operation of the monitoring data recording device included in the monitoring system according to the first example embodiment.

FIG. 16 is a flowchart for explaining an example of an operation of the management device included in the monitoring system according to the first example embodiment.

FIG. 17 is a flowchart for explaining an example of an operation of the video analysis device included in the monitoring system according to the first example embodiment.

FIG. 18 is a flowchart for explaining an example of an operation of the management terminal included in the monitoring system according to the first example embodiment.

FIG. 19 is a block diagram illustrating an example of a configuration of a management device according to a second example embodiment.

FIG. 20 is a conceptual diagram illustrating an example of display information displayed on a screen of a management terminal included in a monitoring system according to the second example embodiment.

FIG. 21 is a block diagram illustrating an example of a hardware configuration included in the device or the terminal according to each example embodiment.

### EXAMPLE EMBODIMENT

Hereinafter, example embodiments of the present invention will be described with reference to the drawings. Note that the example embodiments described below have technically preferable limitations for carrying out the present invention, but the scope of the invention is not limited to the following description. In all the drawings used in the following description of the example embodiments, the same reference numerals are assigned to the same parts unless there is a particular reason. Further, in the following example embodiments, repeated description of similar configurations and operations may be omitted. In addition, the directions of the arrows in the drawings illustrate an example, and do not limit the directions of signals between blocks.

### First Example Embodiment

First, a monitoring system according to a first example embodiment will be described with reference to the drawings. The monitoring system according to the present example embodiment displays, on a screen, an event having a high importance level determined based on a type, an evaluation value, and the like in a highlighted manner among events detected in a video captured by a monitoring terminal.

### Configuration

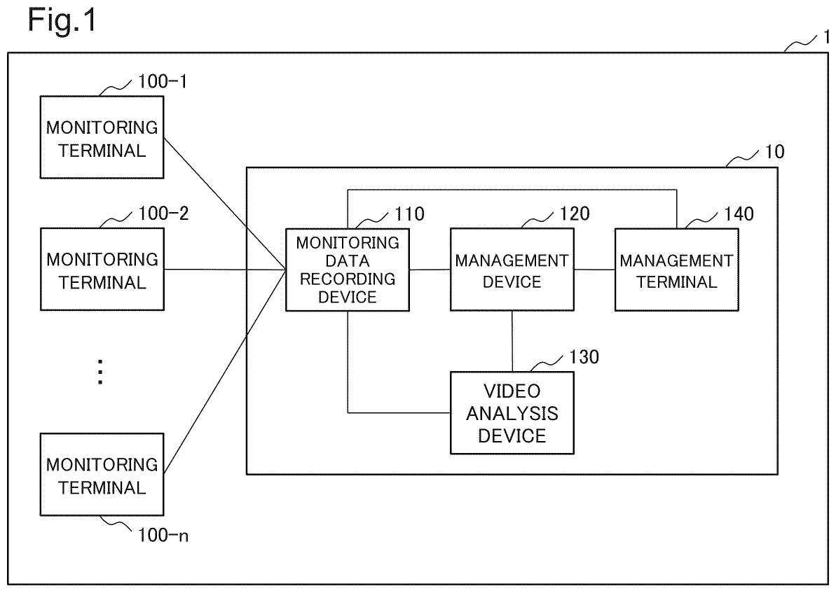

FIG. 1 is a block diagram illustrating an example of a configuration of a monitoring system 1 of the present example embodiment. As illustrated in FIG. 1, the monitoring system 1 includes at least one of monitoring terminals 100-1 to 100-n, a monitoring data recording device 110, a management device 120, a video analysis device 130, and a management terminal 140 (n is a natural number). The monitoring data recording device 110, the management device 120, the video analysis device 130, and the management terminal 140 constitute a management system 10. In the present example embodiment, the management terminal 140 is configured separately, but the management terminal 140 may be included in the management device 120 or the video analysis device 130.

The monitoring terminals 100-1 to 100-n are disposed at positions where an image of a monitoring target range can be captured. For example, the monitoring terminals 100-1 to 100-n are arranged on a street or in a room with many people. Hereinafter, in a case where the individual monitoring terminals 100-1 to 100-n are not distinguished from each other, they are referred to as monitoring terminals 100 without the last letters of the reference signs.

The monitoring terminal 100 captures an image of a monitoring target range and generates video data. The monitoring terminal 100 generates monitoring data in which the generated video data is associated with metadata of the video data. The monitoring terminal 100 outputs the generated monitoring data to the monitoring data recording device 110. For example, the monitoring terminal 100 associates metadata including a location where the monitoring terminal 100 is placed, an individual identification number of the monitoring terminal 100, capturing time of the video data, and the like with the video data.

Further, the monitoring terminal 100 analyzes the taken video data and detects an event occurred in the monitoring target range. For example, the monitoring terminal 100 functions as an edge computer that analyzes each frame image constituting the video data and detects an event occurring in the monitoring target range. For example, the monitoring terminal 100 includes a video analysis engine capable of detecting a predetermined event. For example, the analysis engine included in the monitoring terminal 100 has a function of performing video analysis by artificial intelligence (AI). For example, the monitoring terminal 100 analyzes a plurality of consecutive frame images included in the video data, and detects an event occurring in the monitoring target range. For example, the monitoring terminal 100 detects, in the video data, an event such as a sleeping person, stealing, leaving behind, a crowd (onlookers), tumbling, speed changes, wandering, or a vehicle. Note that the event detected by the monitoring terminal 100 is not limited to the above detection items. The event detected by the monitoring terminal 100 may not be all of the above detection items.

When an event is detected in the video data, the monitoring terminal 100 adds a type of the detected event (a sleeping person, stealing, leaving behind, a crowd (onlookers), tumbling, speed changes, wandering, a vehicle, and the like) to the metadata. When the type of the event is added to the metadata, the capturing time of the video data is relevant to the time when the event is detected (hereinafter, also referred to as detection time.). The detection time of the event can be regarded as the same time as the occurrence time of the event.

In addition, when detecting an event in the monitoring target range, the monitoring terminal 100 determines the importance level from a combination of types of the events, an evaluation value (a score output based on similarity or certainty of the event), and the like. The monitoring terminal 100 adds the importance level of the determined event to the metadata of the video data in which the event is detected. For example, a type of an event, an evaluation value of the event, and the like, and an importance level determined from the event are also referred to as event-related information.

The setting of the importance level determined based on the combination of the event types, the evaluation value, and the like by the monitoring terminal 100 will be described. For example, the monitoring terminal 100 sets weighting of the importance level of the event according to the type of the event. Alternatively, the monitoring terminal 100 sets the weighting of the importance level of the event according to the combination of the events. For example, when a first event and a second event are detected simultaneously or continuously, the monitoring terminal 100 sets the importance level of the events (also referred to as an incident event) based on these events higher, for example, a greater value than that in a case of a single event.

In addition, in the setting of the importance level, the monitoring terminal 100 may calculate similarity or certainty that a target detected in the input video data relevant to any event included in the detection item. The similarity and the certainty in this case are obtained, for example, by deep learning using a neural network (NN). For example, the NN inputs video data, performs an event determination process, and outputs similarity and certainty of an event from an output layer. Furthermore, in a case where the degree of similarity or certainty of an event relevant to the target detected in the video data is greater than a threshold value, the monitoring terminal 100 sets the importance level of the event higher, for example, sets the importance level to a greater value.

The monitoring data recording device 110 acquires monitoring data from the monitoring terminal 100. The monitoring data recording device 110 records the monitoring data for each monitoring terminal 100 that is a transmission source of the monitoring data.

In addition, the monitoring data recording device 110 outputs the metadata included in the accumulated monitoring data to the management device 120 at a preset timing. For example, when acquiring the monitoring data from the monitoring terminal 100, the monitoring data recording device 110 immediately outputs the metadata included in the monitoring data to the management device 120. For example, the monitoring data recording device 110 outputs the metadata included in the monitoring data to the management device 120 at predetermined time intervals. For example, when receiving a request for metadata in a certain time zone from the management device 120, the monitoring data recording device 110 outputs the metadata in the time zone to the management device 120 as a transmission source in response to the request.

In addition, the monitoring data recording device 110 outputs the video data included in the monitoring data to the video analysis device 130 at a preset timing. For example, the monitoring data recording device 110 outputs the video data included in the monitoring data to the video analysis device 130 at predetermined time intervals. For example, when receiving a request for video data in a certain time zone from the video analysis device 130, the monitoring data recording device 110 outputs the video data in the time zone to the video analysis device 130 as a transmission source in response to the request.

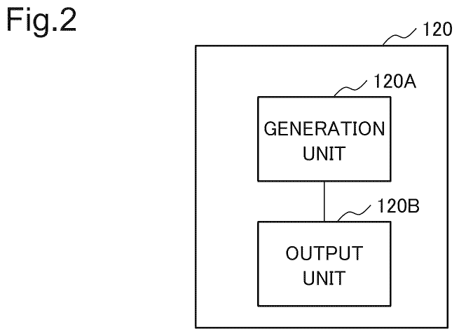

FIG. 2 is a block diagram illustrating an example of a configuration of the management device 120. The management device 120 includes a generation unit 120A and an output unit 120B. The generation unit 120A acquires the metadata included in the monitoring data from the monitoring data recording device 110. When the acquired metadata includes event-related information, the generation unit 120A extracts, from the metadata, a plurality of pieces of data items including an individual identification number of the monitoring terminal 100 that has detected the event, a type of the event included in the metadata, the detection time of the event, and the importance level of the event. Further, the generation unit 120A generates notification information in which a plurality of pieces of extracted item data is associated with each other. The output unit 120B displays the notification information on the screen in a display state according to an icon characterizing the type of the event or the importance level of the event. As described above, since the management device 120 can display the event detected from the video data on the screen in a visually recognizable form, it is possible to efficiently confirm the event detected in the video data.

For example, the generation unit 120A refers to the metadata included in the monitoring data, and determines whether an event is detected in the video data included in the monitoring data. In a case where the metadata includes a type of an event, the generation unit 120A generates notification information including the metadata of the event.

For example, the output unit 120B sets an emphasis level of the notification information of the event according to the importance level determined based on the type of the event, the evaluation value, and the like. The output unit 120B displays the generated notification information on the screen of the management terminal 140. In the display process, for example, the output unit 120B displays the notification information including the detection time of the event, the type of the event, the importance level determined from the type of the event, the evaluation value or the like on the screen of the management terminal 140 according to the emphasis level of the notification information. In the display process, for example, in a case where the emphasis level of the notification information is high, the output unit 120B displays the background and characters of the notification information with a hue, saturation, and brightness emphasized as compared with the notification information with a low emphasis level. The output unit 120B may display the notification information of the event not on the screen of the management terminal 140 but on the screen of the management device 120 in a display state according to the emphasis level.

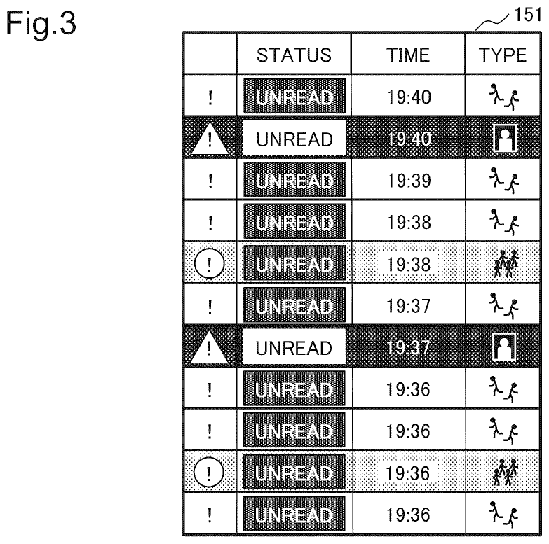

FIG. 3 is a display example of a field including notification information generated by setting the emphasis level of the output unit 120B. FIG. 3 is a display example of display information (display information 151) in which a plurality of fields is arranged in time series. Each of the plurality of fields included in the display information 151 is arranged in descending order by using the detection time (time in FIG. 3) included in the field as a key. Note that each of the plurality of fields included in the display information 151 may be arranged in ascending order with the detection time included in each of the fields as a key. In addition, each of the plurality of fields included in the display information 151 may be sorted using items such as the importance level of the event, the status, and the type of the event included in the fields as keys.

In the example of FIG. 3, a mark indicating the importance level of the event is displayed in the first column from the left of the display information 151. In the second column from the left of the display information 151, a status indicating whether the event has been confirmed by the user is displayed. For example, the status is kept to “unread” before the field for the event is selected by the user, then changed to “read” after the field for the event is selected by the user, and to “supported” after an action on the event is taken by the user. The third column from the left of the display information 151 displays the detection time of the event. In the fourth column from the left of the display information 151, an icon indicating the type of the event is displayed.

The icon indicating the classification of the event preferably has a design that helps grasping of the feature of the event.

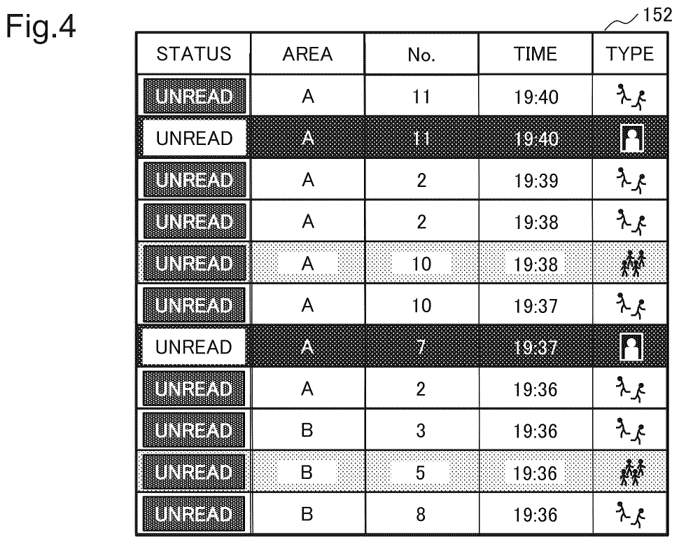

FIG. 4 is another display example of the fields including the notification information generated by the generation unit 120A. FIG. 4 is a display example of display information (display information 152) in which a plurality of fields is arranged in time series. Similarly to the display information 151 in FIG. 3, the plurality of fields included in the display information 152 is arranged in descending order with the detection time of the event included in the fields as a key. Note that each of the plurality of fields included in the display information 152 may be arranged in ascending order with the detection time of the event included in the fields as a key. In addition, each of the plurality of fields included in the display information 152 may be sorted using items such as a placed area, an individual identification number of the monitoring terminal 100, and a type of an event included in the fields as keys.

As illustrated in FIG. 4, in the first column from the left of the display information 152, a status indicating whether the event has been confirmed by the user is displayed. For example, the status is kept to “unread” before the field for the event is selected by the user, then changed to “read” after the field for the event is selected by the user, and to “supported” after an action on the event is taken by the user. In the second column from the left of the display information 152, the area name in which the monitoring terminal 100 that has detected the event is placed is displayed. The third column from the left of the display information 152 displays the individual identification number of the monitoring terminal 100 that has detected the event. The fourth column from the left of the display information 152 displays the detection time of the event. In the fifth column from the left of the display information 152, an icon indicating the type of the event is displayed.

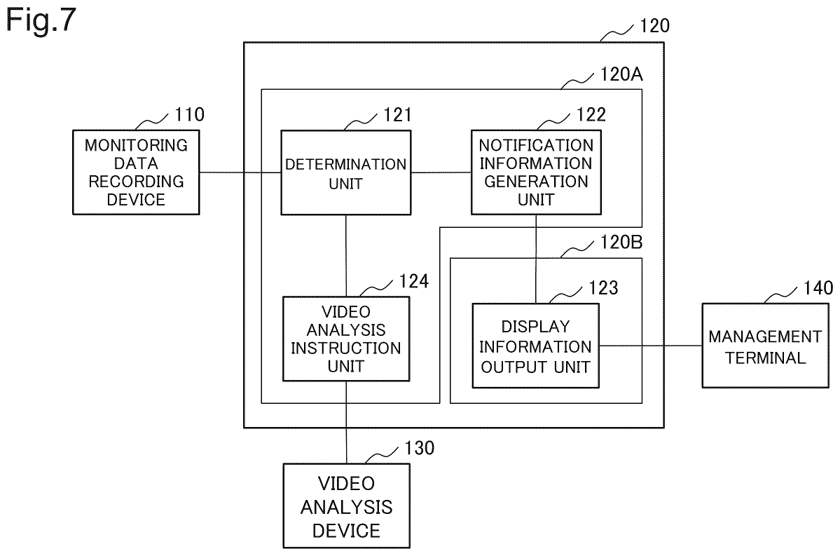

As illustrated in FIGS. 3 and 4, the field related to the notification information of each event is highlighted according to the importance level determined from the type, evaluation value, and the like of the event. For example, in a case where the importance level of the event is emphasized by color, the output unit 120B sets the background of the field of the event with high importance level to a color that is conspicuous as compared with the fields of the other events. For example, in a case where the importance level of the event is emphasized by color, the output unit 120B sets the background of the field of the event with high importance level to a color with higher saturation, brightness, and brightness than those of the fields of other events. For example, in a case where the importance level of the event is emphasized by shading, the output unit 120B makes the background of the field of the event with high importance level darker than the background of the fields of the other events. For example, the management device 120 changes the color and density of the text, icons, and marks displayed in each field to a color and density that are easy to see with respect to the background. For example, the emphasis level of the field related to the notification information of each event may be changed according to the elapsed time after the event is detected, the elapsed time after the field is displayed, or the like. Note that FIGS. 3 and 4 are examples, and do not limit the display information displayed by the output unit 120B. An example of the configuration of the management device 120 will be described in more detail later with reference to FIG. 7.

In the first example embodiment, the management device 120 has a function of issuing an instruction to analyze video data to the video analysis device 130. For example, when the type of the event is included in the metadata, the management device 120 issues an instruction to analyze the video data in the time zone including the detection time of the event to the video analysis device 130. The management device 120 acquires an analysis result by the video analysis device 130 according to the analysis instruction. The management device 120 generates notification information including an event detected by analysis by the video analysis device 130. Note that the management device 120 may acquire the analysis result by the video analysis device 130 and generate the notification information including the event detected by the video analysis device 130 regardless of the presence or absence of the analysis instruction.

The video analysis device 130 acquires the video data included in the monitoring data from the monitoring data recording device 110 at a preset timing. In addition, the video analysis device 130 acquires video data from the monitoring data recording device 110 in response to an analysis instruction from the management device 120. For example, the video analysis device 130 includes a video analysis engine capable of detecting a preset event. For example, the analysis engine included in the video analysis device 130 has a function of performing video analysis by the AI. For example, the video analysis device 130 detects, from the video data, a detection target such as a sleeping person, stealing, leaving behind, a crowd (onlookers), tumbling, speed changes, wandering, or a vehicle. Note that the event detected by the video analysis device 130 is not limited to the above detection items. In addition, the events detected by the video analysis device 130 may not be all of the above detection items. The performance of the analysis engine of the video analysis device 130 is preferably higher than the performance of the analysis engine of the monitoring terminal 100. In addition, the detection item of the video analysis device 130 may be the same as or different from the detection item of the monitoring terminal 100.

The video analysis device 130 analyzes the acquired video data and detects an event from the video data. For example, the video analysis device 130 analyzes each frame image constituting the video data, and detects an event occurring in the monitoring target range. For example, the video analysis device 130 detects a sleeping person, stealing, leaving behind, a crowd (enclosure), tumbling, speed changes, wandering, a vehicle, and the like from the video data. When events are detected in the monitoring target range, the video analysis device 130 determines the importance level from a combination of types of the events, an evaluation value, and the like. The video analysis device 130 generates an analysis result in which an event detected in video data is associated with an importance level determined based on the type, the evaluation value, or the like of the event. The video analysis device 130 outputs the generated analysis result to the management device 120.

The management terminal 140 has a screen on which the field including the notification information generated by the management device 120 is displayed. The management terminal 140 may be configured by a device different from the management device 120 or may be configured as a part of the management device 120. The management terminal 140 displays the field including the notification information generated by the management device 120 on the screen. For example, the management terminal 140 displays, on the screen, display information in which the fields including the notification information generated by the management device 120 are arranged in time series. For example, the management terminal 140 collectively displays or switches the plurality of pieces of video data taken by the plurality of monitoring terminals 100-1 to 100-n on the screen. For example, the management terminal 140 displays a user interface for switching videos in a window separately from the window in which the video is displayed.

The management terminal 140 receives an operation by the user via an input device such as a keyboard or a mouse and changes the notification information displayed on the screen. For example, the management terminal 140 displays the status of each piece of notification information to “unread” before the field is selected, and then changes to “read” after the field is selected, and to “supported” after the action for the event in the field is taken according to the operation by the user.

Next, details of each component included in the monitoring system 1 of the present example embodiment will be described with reference to the drawings. The following components are merely examples, and the components included in the monitoring system 1 of the present example embodiment are not limited to the forms as they are.

### Monitoring Terminal

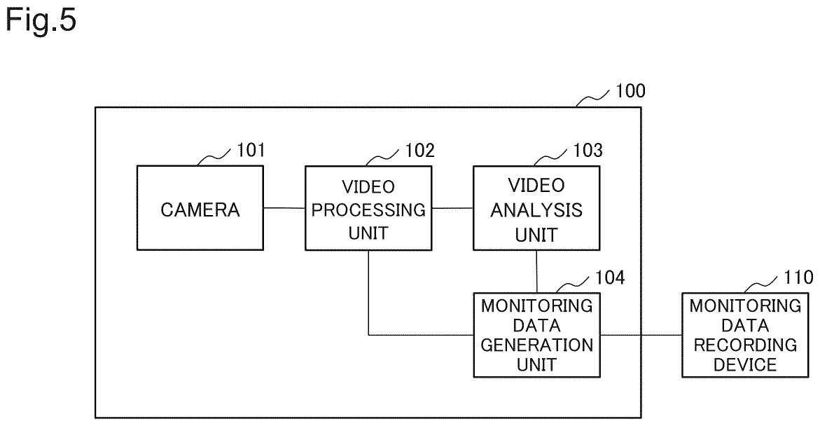

FIG. 5 is a block diagram illustrating an example of a configuration of the monitoring terminal 100. The monitoring terminal 100 includes a camera 101, a video processing unit 102, a video analysis unit 103, and a monitoring data generation unit 104. FIG. 5 also illustrates the monitoring data recording device 110 in addition to the monitoring terminal 100.

The camera 101 is placed at a position where the monitoring target range can be captured. The camera 101 captures an image of the monitoring target range at a preset capture interval, and generates video data. The camera 101 outputs the captured video data to the video processing unit 102. The camera 101 may be a general camera sensitive to a visible region or an infrared camera sensitive to an infrared region. For example, the range of the angle of view of the camera 101 is set as the monitoring target range. For example, the capturing direction of the camera 101 is switched according to an operation from the management terminal 140 or control from an external host system. For example, the capturing direction of the camera 101 is changed at a predetermined timing.

The video processing unit 102 acquires video data from the camera 101. The video processing unit 102 processes the video data to form in a data format that can be analyzed by the video analysis unit 103. The video processing unit 102 outputs the processed video data to the video analysis unit 103 and the monitoring data generation unit 104. For example, the video processing unit 102 performs at least one of processing such as dark current correction, interpolation operation, color space conversion, gamma correction, aberration correction, noise reduction, and image compression on the frame image constituting the video data. Note that the processing on the video data by the video processing unit 102 is not limited to that described herein. In addition, if there is no need to process the video data, the video processing unit 102 may be omitted.

The video analysis unit 103 acquires the processed video data from the video processing unit 102. The video analysis unit 103 detects an event from the acquired video data. When events are detected from the video data, the video analysis unit 103 determines the importance level from a combination of types of detected events, an evaluation value, and the like. The video analysis unit 103 outputs an event detected in the video data and an importance level determined from a type, an evaluation value, or the like of the event in association with each other to the monitoring data generation unit 104.

For example, the video analysis unit 103 includes a video analysis engine capable of detecting a preset event. For example, the analysis engine included in the video analysis unit 103 has a function of performing video analysis by artificial intelligence (AI). For example, the video analysis unit 103 detects an event such as a sleeping person, stealing, leaving behind, a crowd (onlookers), tumbling, speed changes, wandering, or a vehicle. For example, the video analysis unit 103 may compare video data of at least two time zones having different capturing time zones and detect an event based on a difference between the video data.

For example, the video analysis unit 103 detects a sleeping person based on a detection condition capable of detecting a person sitting on the ground and a person lying down. For example, the video analysis unit 103 detects the stealing of baggage based on a detection condition capable of detecting the stealing baggage such as a bag or a wallet placed around a sleeping person. For example, the video analysis unit 103 detects leaving behind based on a detection condition capable of detecting that an object left behind/discarded is a designated object. For example, the designated object is a bag or the like.

For example, the video analysis unit 103 detects a crowd based on a detection condition capable of detecting a crowd in a specific area. Note that it is preferable to designate ON/OFF of crowd detection and crowd duration in order to avoid erroneous detection in an area where a crowd may constantly occur, such as near an intersection. For example, the video analysis unit 103 detects tumbling based on a detection condition capable of detecting a person who has fallen on the ground. For example, the video analysis unit 103 detects the tumbling based on a detection condition capable of detecting that a person riding on the two-wheeled vehicle has fallen onto the ground.

For example, in a case where an object is continuously shown within the same angle of view, the video analysis unit 103 detects wondering on based on a detection condition capable of tracking and detecting an object even during a pan-tilt-zoom operation and detecting the object staying in the specific area for a certain period. The object to be subjected to the wandering detection includes a vehicle such as an automobile or a two-wheeled vehicle, and a person.

For example, the video analysis unit 103 detects a vehicle based on a detection condition capable of detection a vehicle such as a two-wheeled vehicle or an automobile staying in a specific area for a certain period and detecting traffic jam. Note that, in order to distinguish from a constant stagnation caused by a red light or the like, it is preferable that the vehicle is detected by a combination with detection of tumbling of a person. For example, the video analysis unit 103 detects tumbling based on a detection condition capable of detecting a state in which a person has fallen on the ground. For example, the video analysis unit 103 detects a speed change from a low speed state of about 3 to 5 km/h to a high speed state of equal to or more than 10 km/h.

The monitoring data generation unit 104 acquires the video data from the video processing unit 102. The monitoring data generation unit 104 generates monitoring data in which the acquired video data is associated with metadata of the video data. For example, the metadata of the video data includes a location where the monitoring terminal 100 is disposed, an identification number of the monitoring terminal 100, capturing time of the video data, and the like. The monitoring data generation unit 104 outputs the generated monitoring data to the monitoring data recording device 110.

In addition, when an event is detected from the video data, the monitoring data generation unit 104 acquires, from the video analysis unit 103, the event detected from the video data and the importance level determined from the type, the evaluation value, and the like of the event. The monitoring data generation unit 104 adds the event detected from the video data and the importance level determined from the type, the evaluation value, and the like of the event to the metadata in association with each other. The monitoring data generation unit 104 outputs, to the monitoring data recording device 110, the monitoring data in which the event detected from the video data and the importance level determined from the type, the evaluation value, and the like of the event are added to the metadata. Note that the importance level of the event may be determined by the management device 120 without being determined by the monitoring terminal 100.

### Monitoring Data Recording Device

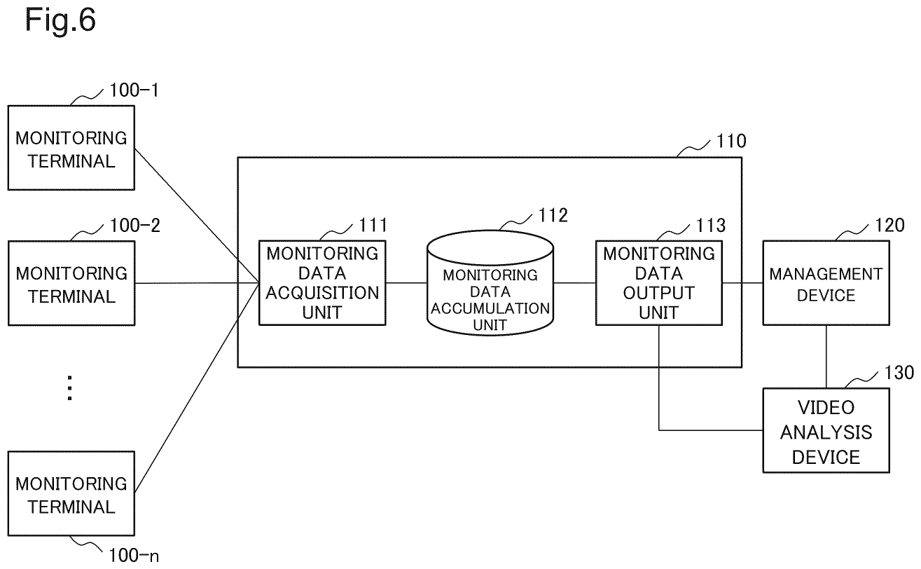

FIG. 6 is a block diagram illustrating an example of a configuration of monitoring data recording device 110. The monitoring data recording device 110 includes a monitoring data acquisition unit 111, a monitoring data accumulation unit 112, and a monitoring data output unit 113. Note that FIG. 6 illustrates the monitoring terminals 100-1 to 100-n, the management device 120, and the video analysis device 130 in addition to the monitoring data recording device 110.

The monitoring data acquisition unit 111 acquires the monitoring data generated by each of the plurality of monitoring terminals 100-1 to 100-n (hereinafter, referred to as a monitoring terminal 100) from each of the plurality of monitoring terminals 100. The monitoring data acquisition unit 111 records the acquired monitoring data in the monitoring data accumulation unit 112 for each monitoring terminal 100 that is a generation source of the monitoring data.

The monitoring data accumulation unit 112 accumulates the monitoring data generated by each of the plurality of monitoring terminals 100 in association with the monitoring terminal 100 that is the generation source of the monitoring data.

The monitoring data output unit 113 outputs the output target metadata included in the monitoring data accumulated in the monitoring data accumulation unit 112 to the management device 120 at a preset timing. In addition, the monitoring data output unit 113 outputs the video data to be output included in the monitoring data accumulated in the monitoring data accumulation unit 112 to the video analysis device 130 at a preset timing. In addition, in response to an instruction from the management device 120 or the video analysis device 130, the monitoring data output unit 113 outputs the designated video data among the video data accumulated in the monitoring data accumulation unit 112 to the video analysis device 130 as a designation source.

### Management Device

FIG. 7 is a block diagram illustrating an example of a configuration of the management device 120. The management device 120 includes a generation unit 120A and an output unit 120B. The generation unit 120A includes a determination unit 121, a notification information generation unit 122, and a video analysis instruction unit 124. The output unit 120B includes a display information output unit 123. Note that FIG. 7 illustrates the monitoring data recording device 110, the video analysis device 130, and the management terminal 140 in addition to the management device 120.

The determination unit 121 acquires, from the monitoring data recording device 110, the metadata generated by one of the monitoring terminals 100. The determination unit 121 determines whether the type of the event is included in the acquired metadata. When the metadata includes the type of the event, the determination unit 121 issues an instruction to generate the notification information including the metadata of the event to the notification information generation unit 122.

In addition, the determination unit 121 issues an instruction to analyze the video data to the video analysis instruction unit 124. For example, when the type of the event is included in the metadata, the determination unit 121 issues, to the video analysis instruction unit 124, an instruction to analyze the video data in the time zone (also referred to as a designated time zone) including the detection time of the event among the video data generated by the monitoring terminal 100 that has detected the event. The management device 120 acquires an analysis result by the video analysis device 130 according to the analysis instruction. Note that the determination unit 121 may acquire the analysis result by the video analysis device 130 regardless of the presence or absence of the analysis instruction. The determination unit 121 issues an instruction to generate notification information including metadata of an event detected by analysis by the video analysis device 130 to the notification information generation unit 122.

Notification information generation unit 122 generates the notification information including the metadata of the event according to the instruction of determination unit 121. In addition, the notification information generation unit 122 generates notification information including the event detected by analysis by the video analysis device 130. For example, the notification information generation unit 122 generates notification information relevant to the importance level determined from the type of the event, the evaluation value, and the like. For example, the notification information generation unit 122 sets the emphasis level of the notification information of the event according to the importance level determined from the type of the event, the evaluation value, and the like. The notification information generation unit 122 outputs the generated notification information to the display information output unit 123.

The display information output unit 123 acquires the notification information from the notification information generation unit 122. The display information output unit 123 outputs the acquired notification information to the management terminal 140. For example, the display information output unit 123 displays the notification information on the screen of the management terminal 140. For example, the display information output unit 123 causes the screen of the management terminal 140 to display the display information including the notification information in which the detection time of the event, the type of the event, and the importance level determined from the type of the event, the evaluation value, and the like are associated with each other.

For example, when the event detected in the analysis by the video analysis device 130 and the event detected by the monitoring terminal 100 are different events, the display information output unit 123 displays the fields of the notification information of these events separately on the screen of the management terminal 140. For example, when the event detected by the analysis by the video analysis device 130 and the event detected by the monitoring terminal 100 are the same event, the display information output unit 123 integrates and displays the fields of the notification information of these events on the screen of the management terminal 140.

For example, in a case where an event detected as a crowd by the monitoring terminal 100 and an event detected as a fallen person by the video analysis device 130 are detected at the same time and at different places, these events are determined to be different events and displayed in different fields. For example, “gathering” is displayed for an event detected as a crowd by the monitoring terminal 100, and “a sleeping person” is displayed for an event detected as a tumbler by the video analysis device 130.

For example, in a case where an event detected as a crowd by the monitoring terminal 100 and an event detected as a fallen person by the video analysis device 130 are detected at close places at the same time, these events are determined to be the same event and displayed in the same field. For example, this event is displayed as “act of violence”.

The video analysis instruction unit 124 outputs an analysis instruction of the determination unit 121 to the video analysis device 130. For example, the video analysis instruction unit 124 instructs the video analysis instruction unit 124 to analyze video data in a time zone (also referred to as a designated time zone) including a detection time of an event among video data generated by the monitoring terminal 100 that has detected the event. The video analysis instruction unit 124 acquires a result analyzed by the video analysis device 130 according to the analysis instruction. The video analysis instruction unit 124 outputs the acquired analysis result to the determination unit 121. Note that the video analysis instruction unit 124 may acquire the analysis result by the video analysis device 130 regardless of the presence or absence of the analysis instruction.

### Video Analysis Device

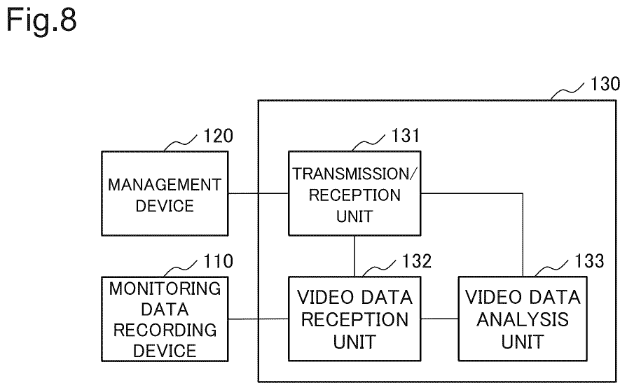

FIG. 8 is a block diagram illustrating an example of a configuration of the video analysis device 130. The video analysis device 130 includes a transmission/reception unit 131, a video data reception unit 132, and a video data analysis unit 133. Note that FIG. 8 illustrates the monitoring data recording device 110 and the management device 120 in addition to the video analysis device 130.

The transmission/reception unit 131 receives the analysis instruction from the management device 120. The transmission/reception unit 131 outputs the received analysis instruction to the video data reception unit 132 and the video data analysis unit 133. Further, the transmission/reception unit 131 acquires an analysis result from the video data analysis unit 133. The transmission/reception unit 131 transmits the acquired analysis result to the management device 120.

The video data reception unit 132 receives video data from monitoring data recording device 110. The video data reception unit 132 outputs the received video data to the video data analysis unit 133. For example, in response to an analysis instruction from the management device 120, the video data reception unit 132 requests the monitoring data recording device 110 for the video data generated by the monitoring terminal 100 designated in the designated time zone. The video data reception unit 132 outputs the video data transmitted in response to the request to the video data analysis unit 133. For example, the video data reception unit 132 outputs the video data transmitted from the monitoring data recording device 110 at a predetermined timing to the video data analysis unit 133.

The video data analysis unit 133 acquires video data from the video data reception unit 132. The video data analysis unit 133 analyzes the acquired video data and detects an event from the video data. For example, the video data analysis unit 133 analyzes each frame image constituting the video data, and detects an event occurred in the monitoring target range.

For example, the video data analysis unit 133 includes a video analysis engine capable of detecting a preset event. For example, the analysis engine included in the video data analysis unit 133 has a function of performing video analysis by AI. For example, the video data analysis unit 133 detects a sleeping person, stealing, leaving behind, a crowd (onlookers), tumbling, speed changes, wandering, a vehicle, and the like from the video data. For example, when an event is detected in the video data, the video data analysis unit 133 determines the importance level from a combination of the type of the event, an evaluation value, and the like. The video data analysis unit 133 generates an analysis result in which an event detected from the video data is associated with an importance level determined from a type, an evaluation value, or the like of the event. The video data analysis unit 133 outputs the generated analysis result to the transmission/reception unit 131.

### Management Terminal

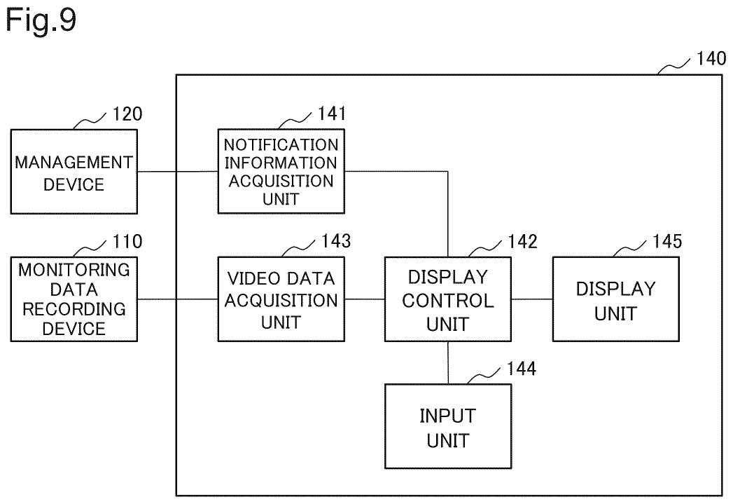

FIG. 9 is a block diagram illustrating an example of a configuration of the management terminal 140. The management terminal 140 includes a notification information acquisition unit 141, a display control unit 142, a video data acquisition unit 143, an input unit 144, and a display unit 145. FIG. 9 illustrates the monitoring data recording device 110 and the management device 120 in addition to the management terminal 140.

The notification information acquisition unit 141 acquires the notification information from the management device 120. The notification information acquisition unit 141 outputs the acquired notification information to the display control unit 142.

The display control unit 142 acquires the notification information from the notification information acquisition unit 141. The display control unit 142 causes the display unit 145 to display the acquired notification information. For example, as illustrated in FIGS. 3 and 4, the display control unit 142 causes the display unit 145 to display display information in which fields including notification information are stacked in time series. For example, the display control unit 142 displays the status of each field to “unread” before the field is selected, and then changes to “read” after the field is selected, and “supported” after an action for the event of the field is taken according to the operation by the user.

For example, the display control unit 142 causes the display unit 145 to display the video data transmitted from the monitoring data recording device 110 at a predetermined timing. For example, the display control unit 142 displays the video data generated by the plurality of monitoring terminals 100 side by side on the display unit 145. Furthermore, the display control unit 142 may output an instruction to acquire the designated video data to the video data acquisition unit 143 according to the designation from the user via the input unit 144. For example, the display control unit 142 acquires the video data transmitted in response to the acquisition instruction from the video data acquisition unit 143 and causes the display unit 145 to display the acquired video data.

The video data acquisition unit 143 acquires video data from the monitoring data recording device 110. For example, the video data acquisition unit 143 receives the designated video data from the monitoring data recording device 110 according to the designation by the display control unit 142. The video data acquisition unit 143 outputs the received video data to the display control unit 142.

The input unit 144 is an input device such as a keyboard or a mouse that receives an operation by a user. The input unit 144 receives an operation by the user via the input device and outputs the received operation content to the display control unit 142.

The display unit 145 includes a screen on which the display information including the notification information generated by the management device 120 is displayed. The display information including the notification information generated by the management device 120 is displayed on the display unit 145. For example, the display unit 145 displays the display information in which the notification information generated by the management device 120 is arranged in time series. For example, on the display unit 145, frame images of a plurality of pieces of video data captured by a plurality of monitoring terminals 100-1 to 100-n are collectively displayed or switched and displayed on a screen.

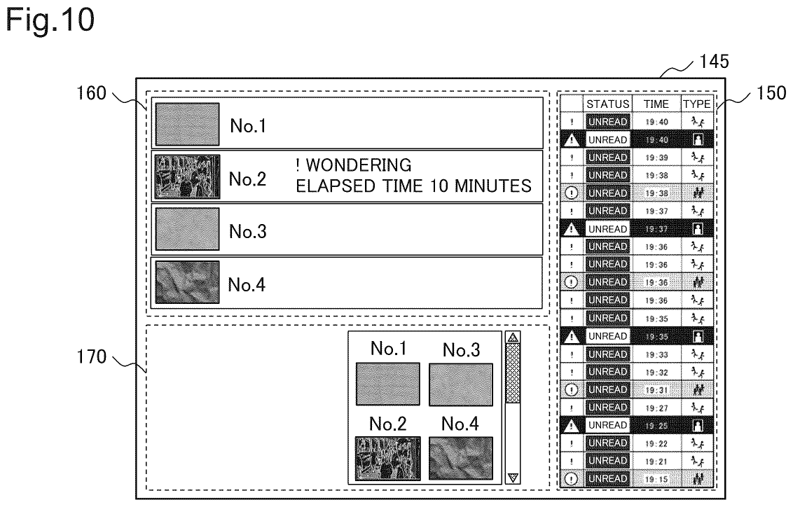

FIG. 10 is a conceptual diagram for describing a display example of the display unit 145. In the example of FIG. 10, the display unit 145 is divided into three display areas. In a first display area 150, display information in which fields including notification information generated by the management device 120 are stacked in time series is displayed. In a second display area 160, videos of each monitoring terminal 100, a support situation and the like to an event detected from the videos are displayed. In a third display area 170, information relevant to an operation from the user is displayed. Note that the videos illustrated in FIG. 10 are schematic and does not accurately represent the video captured by the monitoring terminals 100.

In the first display area 150, display information in which fields including notification information are stacked in time series as illustrated in FIGS. 3 and 4 is displayed. For example, the status of each field is changed according to an operation of the user such that the field before being selected is “unread”, the field after being selected is changed to “read”, and the field that an action on the event of the field is taken is changed to “supported”.

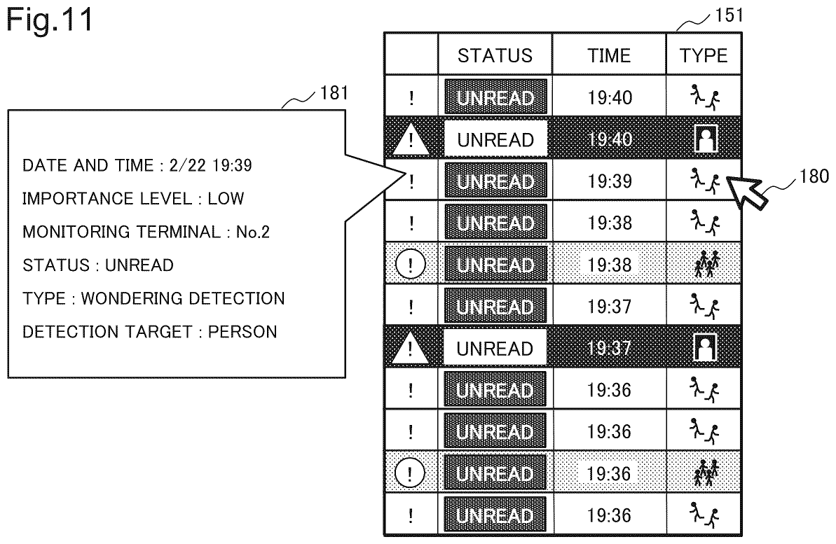

FIG. 11 illustrates an example of displaying a pop-up 181 including detailed data related to an event in a field at a position where a mouse pointer 180 is placed among a plurality of fields included in the display information 151 displayed in the first display area 150. For example, the pop-up 181 displays information such as the time when the event in the field has been detected, the importance level of the event, the individual identification number of the monitoring terminal 100 that has detected the event, the status of the event, the event, and the detected target.

In the second display area 160, reduced versions of the frame images included in the video data in which the event is detected are displayed side by side. For example, the support situation of the event may be displayed in association with an image of an unsupported event among the frame images included in the video data in which the event has been detected. In the example of FIG. 10, it is displayed that ten minutes have elapsed since “wandering” is detected in the video data of the monitoring terminal 100 (monitoring terminal 100-2) with the individual identification number 2. For example, the images displayed in the second display area 160 may be sorted by using the importance level determined from the type of the event and/or the evaluation value included in the frame displayed in the first display area, the status, the detection time, and the type as keys. In addition, when the display information 152 of FIG. 4 is displayed in the first display area 150, the image displayed in the second display area 160 may be sorted by using items such as the area name in which the monitoring terminal 100 is disposed, the individual identification number of the monitoring terminal 100, and the type of the event as keys.

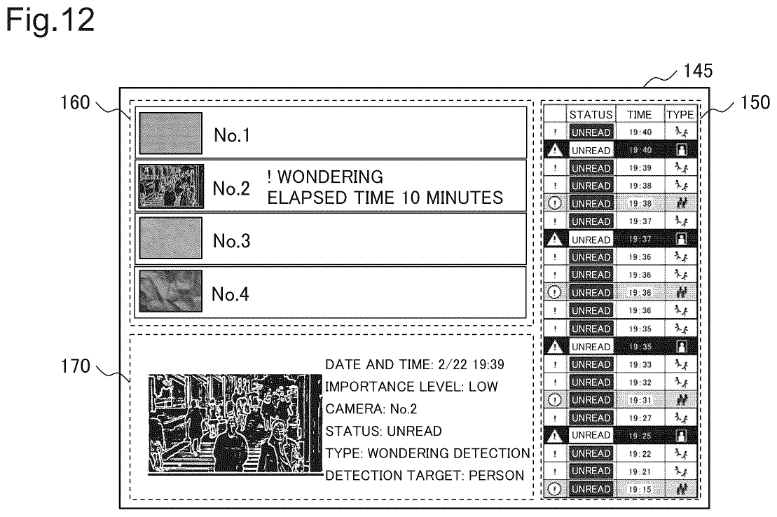

FIG. 12 illustrates an example in which any field in the first display area is clicked and the detection result of the event in the field is displayed in the third display area. In the example of FIG. 12, detailed data regarding the event detected from the original video data of the enlarged image is displayed on the right side of the enlarged image.

In the third display area 170, reduced versions of images captured by the monitoring terminal 100 are displayed side by side. For example, the image is scrolled up and down in response to an operation of a scroll bar on the right side of the image displayed in the third display area 170. For example, when any one of the images displayed in the third display area 170 is clicked, the image is enlarged and displayed.

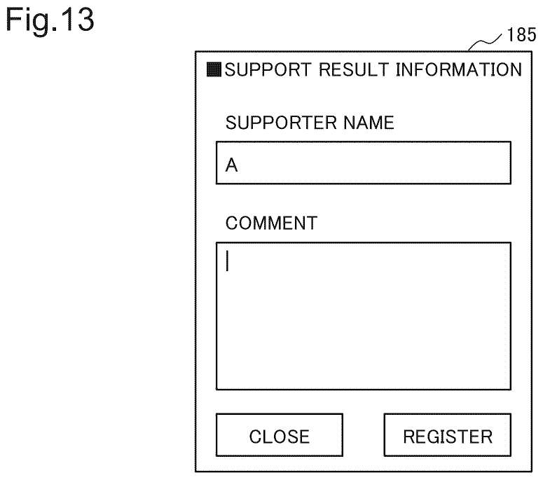

FIG. 13 is an example of a window 185 for inputting support result information for a supported event. For example, the window 185 is opened when a field of the first display area 150 is selected or clicked. In the example of FIG. 13, the window 185 includes a name (supporter name) of the user who supported the event and a comment field. For example, when a registration button is clicked in a state where the name of the supporter and the comment are input, the status of the field becomes “support completed”. When the registration button is clicked, the field may be deleted or the display state may be changed.

### Operation

Next, an operation of the monitoring system 1 of the present example embodiment will be described with reference to the drawings.

Hereinafter, the operation of each component included in the monitoring system 1 will be individually described.

### Monitoring Terminal

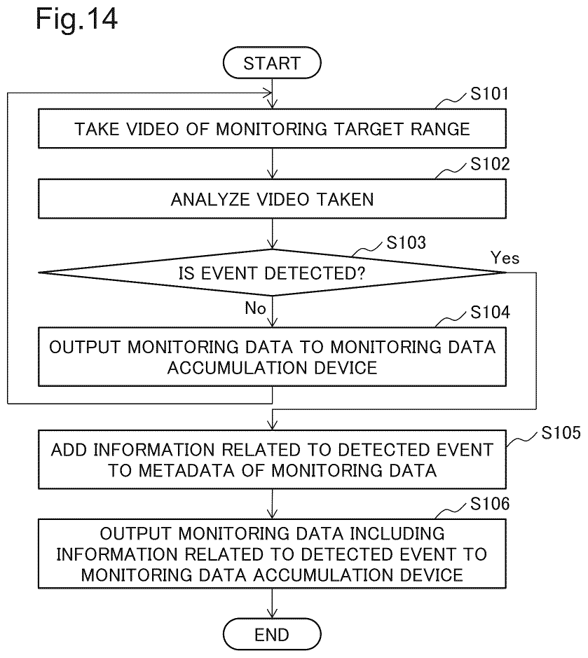

FIG. 14 is a flowchart for explaining an example of the operation of the monitoring terminal 100. In the description along the flowchart of FIG. 14, the monitoring terminal 100 will be described as a main subject of the operation.

In FIG. 14, first, the monitoring terminal 100 takes a video of a monitoring target range (step S101).

Next, the monitoring terminal 100 analyzes the video data taken (step S102).

Here, when an event is detected from the video data (Yes in step S103), the monitoring terminal 100 adds information on the detected event to the metadata of the monitoring data (step S105). The monitoring terminal 100 adds, to the metadata, the type of the event and the importance level determined based on the type of the event, the evaluation value, and the like as the event-related information.

Next, the monitoring terminal 100 outputs monitoring data including the information on the detected event to the monitoring data recording device (step S106). After step S106, the process according to the flowchart of FIG. 14 may be ended, or the process may return to step S101 to continue the process.

On the other hand, when no event is detected from the video data in step S103 (No in step S103), the monitoring terminal 100 generates monitoring data in which metadata is added to the video data, and outputs the generated monitoring data to the monitoring data recording device 110 (step S104). After step S104, the process may return to step S101 to continue the process, or the process according to the flowchart of FIG. 14 may be ended.

### Monitoring Data Recording Device

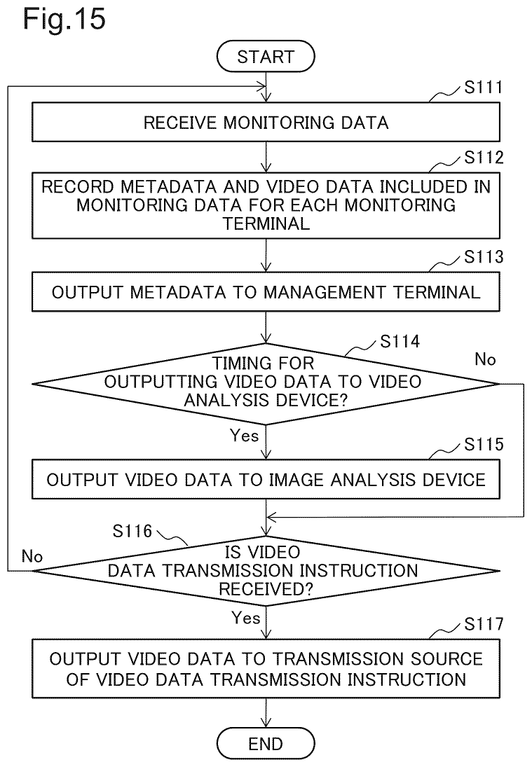

FIG. 15 is a flowchart for explaining an example of the operation of the monitoring data recording device 110. In the description along the flowchart of FIG. 15, the monitoring data recording device 110 will be described as a main subject of the operation.

In FIG. 15, first, monitoring data recording device 110 receives the monitoring data from monitoring terminal 100 (step S111).

Next, the monitoring data recording device 110 records the metadata and the video data included in the monitoring data for each monitoring terminal (step S112).

Next, the monitoring data recording device 110 outputs the metadata to the management device 120 (step S113).

Here, in the case of the timing of outputting the video data to the video analysis device 130 (Yes in step S114), the monitoring data recording device 110 outputs the video data to the video analysis device 130 (step S115). After step S115, the process proceeds to step S116. On the other hand, when it is not the timing to output the video data to the video analysis device 130 in step S114 (No in step S114), the process also proceeds to step S116.

Here, when receiving video data transmission instruction (Yes in step S116), the monitoring data recording device 110 outputs the video data to the transmission source of the video data transmission instruction (step S117). After step S117, the process according to the flowchart of FIG. 15 may be ended, or the process may return to step S111 to continue the process.

On the other hand, when the video data transmission instruction is not received in step S116 (No in step S116), the process may return to step S111 to continue the process, or the process according to the flowchart in FIG. 15 may be ended.

### Management Device

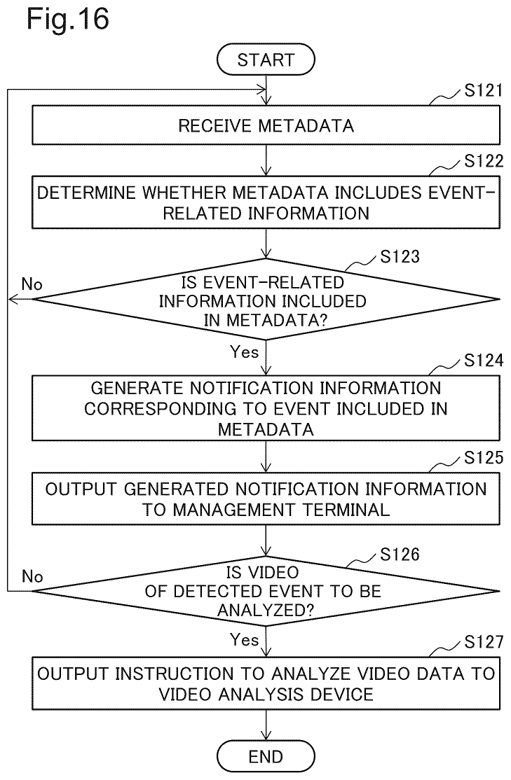

FIG. 16 is a flowchart for explaining an example of the operation of the management device 120. In the description along the flowchart of FIG. 16, the management device 120 will be described as a main subject of the operation.

In FIG. 16, first, the management device 120 receives the metadata from the monitoring data recording device 110 (Step S121).

Next, the management device 120 determines whether the received metadata includes event-related information (step S122).

Here, when the event-related information is included in the metadata (Yes in step S123), the management device 120 generates notification information relevant to the event included in the metadata (step S124). For example, when the analysis result of the monitoring terminal 100 and the analysis result of the video analysis device 130 are integrated as one event, the management device 120 generates notification information in which information of a plurality of pieces of metadata is integrated. On the other hand, when the event-related information is not included in the metadata (No in step S123), the process returns to step S121.

After step S124, the management device 120 outputs the generated notification information to the management terminal 140 (Step S125).

Here, when the video in which the event is detected is analyzed (Yes in step S126), the management device 120 outputs an instruction to analyze the video data in which the event is detected to the video analysis device (step S127). After step S127, the process according to the flowchart of FIG. 16 may be ended, or the process may return to step S121 to continue the process.

On the other hand, when the video in which the event is detected is not analyzed in step S126 (No in step S126), the process may return to step S121 to continue the process, or the process according to the flowchart of FIG. 16 may be ended.

### Video Analysis Device

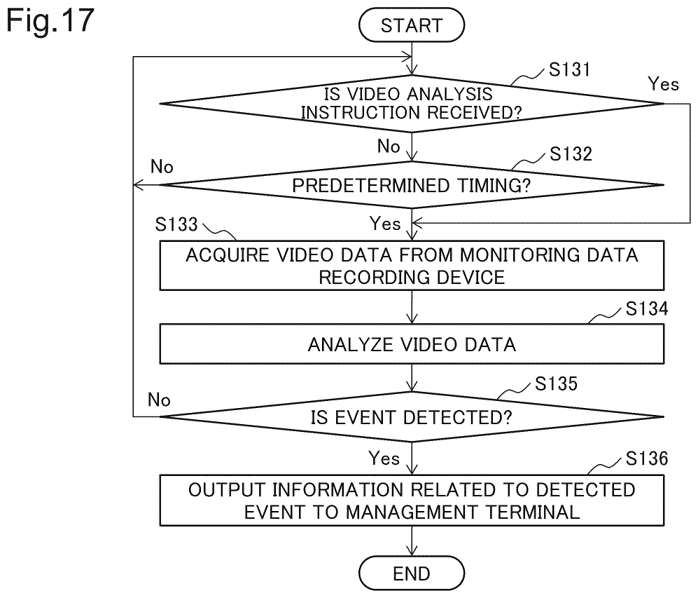

FIG. 17 is a flowchart for explaining an example of the operation of the video analysis device 130. In the description along the flowchart of FIG. 17, the video analysis device 130 will be described as a main subject of the operation.

In FIG. 17, first, when receiving a video analysis instruction (Yes in step S131), the video analysis device 130 acquires video data to be analyzed from the monitoring data recording device 110 (step S133). When a video analysis instruction is not received (No in step S131) and the predetermined timing elapses (Yes in step S132), the video analysis device 130 also acquires the video data to be analyzed from the monitoring data recording device 110. If the predetermined timing has not elapsed in step S132 (No in step S132), the process returns to step S131.

After step S133, the video analysis device 130 analyzes the video data to be analyzed (step S134).

When an event is detected from the video data (Yes in step S135), the video analysis device 130 outputs information on the detected event to the management device 120 (step S136). After step S136, the process according to the flowchart of FIG. 17 may be ended, or the process may be return to step S131 to continue the process.

On the other hand, when no event is detected from the video data in step S135 (No in step S135), the process may return to step S131 to continue the process, or the process according to the flowchart in FIG. 17 may be ended. Note that, in a case where the video analysis instruction has been received in step S131 (Yes in step S131), a result that no event has been detected may be returned from the video analysis device 130 to the transmission source of the video analysis instruction.

### Management Terminal

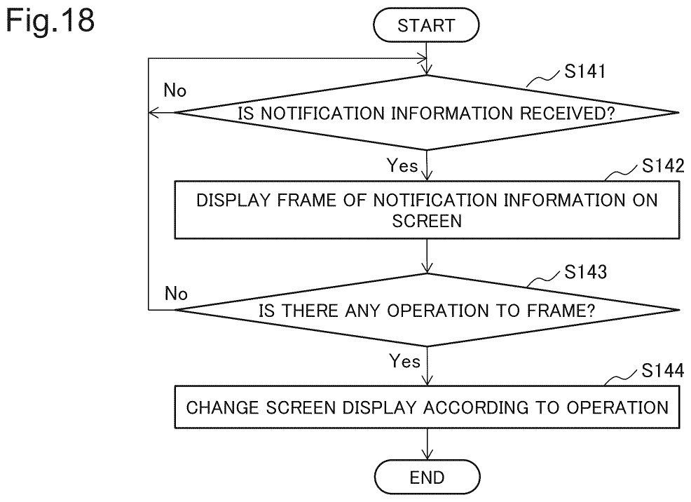

FIG. 18 is a flowchart for explaining an example of the operation of the management terminal 140. In the description along the flowchart of FIG. 18, the management terminal 140 will be described as a main subject of the operation.

In FIG. 18, first, when the notification information is received (Yes in step S141), the management terminal 140 displays a frame including the notification information on the screen (step S142). On the other hand, when the notification information has not been received (No in step S141), the management terminal 140 waits to receive notification information.

After step S142, when there is an operation on any frame (Yes in step S143), the management terminal 140 changes the screen display according to the operation (step S144). After step S144, the process according to the flowchart of FIG. 18 may be ended, or the process may return to step S141 to continue the process.

On the other hand, in a case where there is no operation on the frame in step S143 (No in step S143), the process may return to step S141 to continue the process, or the process along the flowchart of FIG. 18 may be ended.

As described above, the monitoring system according to the present example embodiment includes at least one monitoring terminal, a monitoring data recording device, a management device, a video analysis device, and a management terminal. The monitoring terminal captures an image of a monitoring target range to generate video data, and detects an event from the video data. The monitoring data recording device records monitoring data in which video data generated by the monitoring terminal and metadata of the video data are associated with each other. The video analysis device analyzes video data included in the monitoring data recorded in the monitoring data recording device, and detects an event from the video data. The notification information generation unit acquires the metadata generated by the monitoring terminal or the video analysis device. When the acquired metadata includes event-related information, the generation unit extracts a plurality of data items from the metadata. The plurality of data items includes an individual identification number of the monitoring terminal that has detected the event, a type of the event included in the metadata, detection time of the event, and an importance level of the event. The generation unit generates notification information in which the extracted plurality of pieces of item data is associated with each other. The output unit causes the notification information to be displayed on the screen of the management terminal in a characteristic icon according to the type of the event or in a display state according to the importance level of the event. The notification information is displayed on the screen of the management terminal in a display state relevant to the importance level of the event.

According to the present example embodiment, since the event detected from the video data can be displayed on the screen in a visually recognizable form, it is possible to efficiently confirm the event detected from the video data.

In one aspect of the present example embodiment, the generation unit extracts at least one of similarity and certainty relevant to the event from the metadata and generates notification information having at least one of the similarity and the certainty relevant to the event included in the extracted metadata as an evaluation value.

In one aspect of the present example embodiment, the output unit displays, on the screen, display information in which fields including an icon characterizing the type of the event and the detection time of the event are arranged in chronological order for a plurality of events. In an aspect of the present example embodiment, the output unit sets the display state such that the field of the event with high importance level is highlighted as compared with the field of the event with low importance level.

In one aspect of the present example embodiment, the generation unit adds an icon relevant to a degree of similarity and a degree of certainty relevant to an event to the notification information. The output unit displays, on the screen, a field to which an icon relevant to the degree of similarity and the degree of certainty relevant to the event has been added.

In one aspect of the present example embodiment, the generation unit adds a status indicating a support situation to an event to the notification information, receives a change in the support situation to the event, and updates the status according to the change in the support situation to the event. The output unit displays the field to which the status is added on the screen.

In the present example embodiment, the type of the event is visualized by the icon, the status indicating the support situation to the event is clearly indicated, and the background color of the field is changed according to the importance level of the event. As a result, according to the present example embodiment, it is possible to intuitively encourage the monitoring staff to confirm the video including the event of high importance level. In addition, according to the present example embodiment, even in a case where the display range of the display information including the notification information is limited, the notification information of the event having a high degree of similarity and high certainty relevant to the event is highlighted, and thus, it is possible to prompt the monitoring staff to access the video data of such an event.

In the present example embodiment, an example of detecting an event in video data has been described. However, the method of the present example embodiment can also be applied to a usage of displaying notification information of an event detected in sensing data other than video data. For example, the method of the present example embodiment can also be applied to a usage of displaying notification information of an event detected in voice data. For example, the method of the present example embodiment can also be applied to a usage of displaying notification information of an event such as scream detected in voice data.

For example, sensing data detected in remote sensing such as light detection and ranging (LIDAR) may be used in the method of the present example embodiment. For example, it can be determined that the detected event is not the detection item according to the distance to the object measured by LIDAR or the like. For example, when the distance to the target is known, the size of the target can be grasped, but when the size of the detection target of the detected event is smaller than expected, erroneous detection may occur. In such a case, the detected event may be determined as erroneous detection and excluded from the display target of the notification information.

### Second Example Embodiment

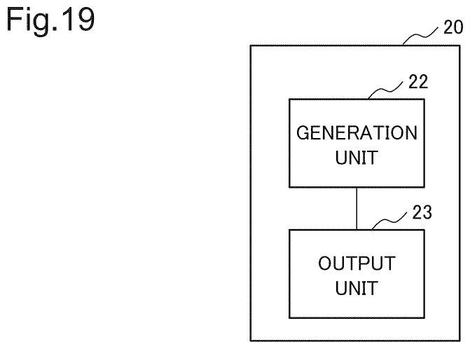

Next, A management device according to a second example embodiment will be described with reference to the drawings. FIG. 19 is a block diagram illustrating an example of a configuration of a management device 20 according to the present example embodiment. The management device 20 includes a generation unit 22 and an output unit 23. The management device 20 has a configuration in which the management device 120 of the first example embodiment is simplified.

The generation unit 22 acquires metadata of video data generated by a monitoring terminal that detects an event from the video data in a monitoring target range. When the acquired metadata includes event-related information, the generation unit 22 extracts the plurality of data items from the metadata. The plurality of data items includes an individual identification number of the monitoring terminal that has detected the event, an icon characterizing a type of the event included in the metadata, a detection time of the event, and an evaluation value of the event. The generation unit 22 generates notification information in which a plurality of pieces of extracted item data is associated with each other.

The output unit 23 displays the notification information on a screen in a display state according to the evaluation value of the event.

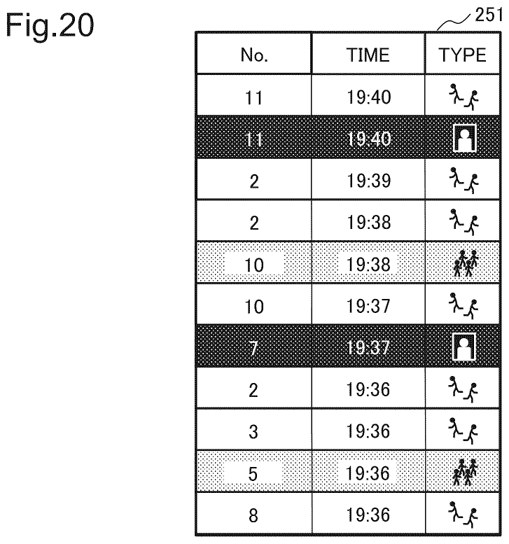

FIG. 20 illustrates an example in which the display information (display information 251) including the notification information generated by the management device 20 is displayed on a screen (not illustrated). Each field included in the display information 251 is relevant to the notification information. For example, the notification information includes the individual identification number of the monitoring terminal that has detected the event, the detection time of the event, and the type of the event. Each piece of the notification information included in the display information 251 is arranged in descending order with the detection time included in the notification information as a key. Note that each piece of the notification information included in the display information 251 may be arranged in ascending order with the detection time included in the notification information as a key. In addition, each piece of the notification information included in the display information 251 may be sorted by using the individual identification number of the monitoring terminal that has detected the event or the type of the event as a key.

Note that at least the detection time of the event and the type of the event may be displayed among the items included in the display information 251.

As described above, the management device according to the present example embodiment includes the generation unit and the output unit. The generation unit acquires metadata of video data generated by a monitoring terminal that detects an event from the video data in a monitoring target range. When the acquired metadata includes event-related information, the generation unit extracts a plurality of data items from the metadata. The plurality of data items includes an individual identification number of the monitoring terminal that has detected the event, an icon characterizing a type of the event included in the metadata, a detection time of the event, and an evaluation value of the event. The generation unit generates notification information in which the extracted plurality of pieces of item data is associated with each other. The output unit displays the notification information on a screen in a display state according to the evaluation value of the event.

According to the present example embodiment, since the event detected from the video data can be displayed on the screen in a visually recognizable form, it is possible to efficiently confirm the event detected from the video data.

### Hardware

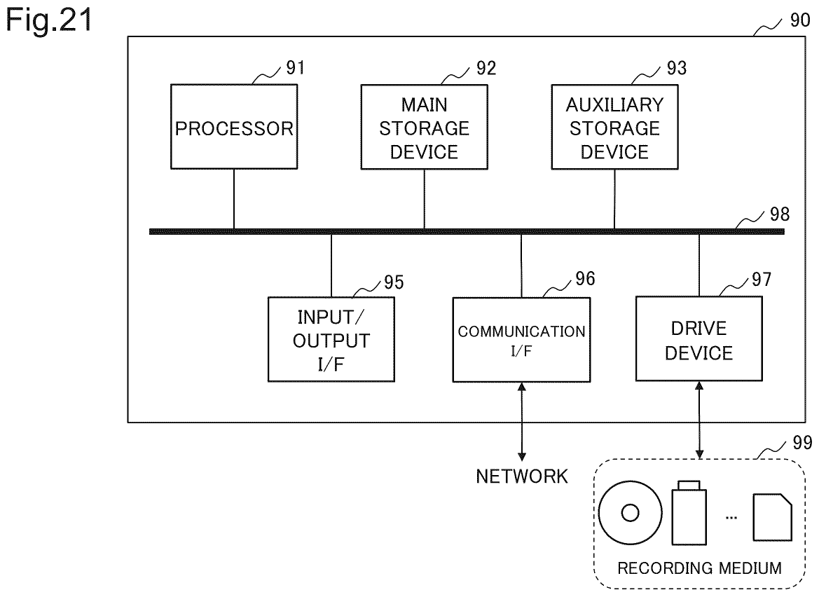

Here, a hardware configuration for executing processing of the device and the terminal according to each example embodiment will be described using an information processing device 90 of FIG. 21 as an example. Note that the information processing device 90 in FIG. 21 is a configuration example for executing processing of the device and the terminal of each example embodiment, and does not limit the scope of the present invention.

As illustrated in FIG. 21, the information processing device 90 includes a processor 91, a main storage device 92, an auxiliary storage device 93, an input/output interface 95, a communication interface 96, and a drive device 97. In FIG. 21, the interface is abbreviated as I/F. The processor 91, the main storage device 92, the auxiliary storage device 93, the input/output interface 95, the communication interface 96, and the drive device 97 are data-communicably connected to each other via a bus 98. In addition, the processor 91, the main storage device 92, the auxiliary storage device 93, and the input/output interface 95 are connected to a network such as the Internet or an intranet via the communication interface 96. In addition, FIG. 21 illustrates a recording medium 99 capable of recording data.

The processor 91 develops the program stored in the auxiliary storage device 93 or the like in the main storage device 92 and executes the developed program. According to the present example embodiment, a software program installed in the information processing device 90 may be used. The processor 91 executes processing by the device or the terminal according to the present example embodiment.

The main storage device 92 has an area in which a program is developed. The main storage device 92 may be a volatile memory such as a dynamic random access memory (DRAM). In addition, a nonvolatile memory such as a magnetoresistive random access memory (MRAM) may be configured/added as the main storage device 92.

The auxiliary storage device 93 stores various data. The auxiliary storage device 93 includes a local disk such as a hard disk or a flash memory. Note that various data may be stored in the main storage device 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet on the basis of a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When a touch panel is used as the input device, the display screen of the display device may also serve as the interface of the input device. Data communication between the processor 91 and the input device may be mediated by the input/output interface 95.

Furthermore, the information processing device 90 may be provided with a display device for displaying information. In a case where a display device is provided, the information processing device 90 preferably includes a display control device (not illustrated) for controlling display of the display device. The display device may be connected to the information processing device 90 via the input/output interface 95.

The drive device 97 is connected to the bus 98. The drive device 97 mediates reading of data and a program from the recording medium 99, writing of a processing result of the information processing device 90 to the recording medium 99, and the like between the processor 91 and the recording medium 99 (program recording medium). When the recording medium 99 is not used, the drive device 97 may be omitted.

The recording medium 99 can be achieved by, for example, an optical recording medium such as a compact disc (CD) or a digital versatile disc (DVD). Furthermore, the recording medium 99 may be achieved by a semiconductor recording medium such as a universal serial bus (USB) memory or a secure digital (SD) card, a magnetic recording medium such as a flexible disk, or another recording medium. In a case where the program executed by the processor is recorded in the recording medium 99, the recording medium 99 is relevant to a program recording medium.

The above is an example of a hardware configuration for enabling the device and the terminal according to each example embodiment. Note that the hardware configuration of FIG. 21 is an example of a hardware configuration for executing processing of the device or the terminal according to each example embodiment and does not limit the scope of the present invention. In addition, a program for causing a computer to execute processing related to the device and the terminal according to each example embodiment is also included in the scope of the present invention. Further, a program recording medium in which the program according to each example embodiment is recorded is also included in the scope of the present invention.

Components of the device and the terminal in each example embodiment can be combined as needed. In addition, the components of the device and the terminal of each example embodiment may be implemented by software or may be implemented by a circuit.

Although the present invention has been described with reference to the example embodiments, the present invention is not limited to the above example embodiments. Various modifications that can be understood by those skilled in the art can be made to the configuration and details of the present invention within the scope of the present invention.

### REFERENCE SIGNS LIST

1 Monitoring system
10 Management system
20 Management device
22 Generation unit
23 Output unit
100 Monitoring terminal
101 Camera
102 Video processing unit
103 Video analysis unit
104 Monitoring data generation unit
110 Monitoring data recording device
111 Monitoring data acquisition unit
112 Monitoring data accumulation unit
113 Monitoring data output unit
120 Management device
121 Determination unit
122 Notification information generation unit
123 Display information output unit
124 Video analysis instruction unit
130 Video analysis device
131 Transmission/reception unit
132 Video data reception unit
133 Video data analysis unit
140 Management terminal
141 Notification information acquisition unit
142 Display control unit
143 video data acquisition unit
144 Input unit
145 Display unit

1. An information displaying method comprising:
determining a first event and time information regarding the first event based on a first video captured by a camera;
displaying first notification information on a display, the first notification information including an icon and the time information; and
changing a display position of the first notification information from a first position to a second position in the display automatically,
wherein the icon indicates a feature regarding the first event, and
wherein the second position is determined based on a number of detected events after the first evet is occurred, and kinds of the detected events respectively.

2. The information displaying method according to claim 1, wherein
the second position is determined to avoid overlaying the icon with second icon related to a second event after the first evet.

3. The information displaying method according to claim 1, wherein
the first event includes an action regarding the package.

4. The information displaying method according to claim 1, further comprising
displaying first image on the display as a first size, and
displaying second image on the display as a second size larger than the first size in response to receiving operation to the first notification information.

5. An information displaying device comprising:
at least one memory storing instructions; and
at least one processor connected to the at least one memory and configured to execute the instructions to:
determine a first event and time information regarding the first event based on a first video captured by a camera;
display first notification information on a display, the first notification information including an icon and the time information; and
change a display position of the first notification information from a first position to a second position in the display automatically,
wherein the icon indicates a feature regarding the first event, and
wherein the second position is determined based on a number of detected events after the first evet is occurred, and kinds of the detected events respectively.

6. The information displaying device according to claim 5, wherein
the second position is determined to avoid overlaying the icon with second icon related to a second event after the first evet.

7. The information displaying device according to claim 5, wherein
the first event includes an action regarding the package.

8. The information displaying device according to claim 5, wherein
the at least one processor is configured to execute the instructions to
display first image on the display as a first size, and
display second image on the display as a second size larger than the first size in response to receiving operation to the first notification information.

9. An information displaying system comprising:
a camera; and
information processing device comprising:
at least one memory storing instructions, and
at least one processor configured to execute the instructions to:
determine a first event and time information regarding the first event based on a first video captured by a camera;
display first notification information on a display, the first notification information including an icon and the time information; and
change a display position of the first notification information from a first position to a second position in the display automatically,
wherein the icon indicates a feature regarding the first event, and
wherein the second position is determined based on a number of detected events after the first evet is occurred, and kinds of the detected events respectively.

10. The information displaying system according to claim 9, wherein
the second position is determined to avoid overlaying the icon with second icon related to a second event after the first evet.

11. The information displaying system according to claim 9, wherein
the first event includes an action regarding the package.

12. The information displaying system according to claim 9, wherein
the processor is configured to execute the instructions to
display first image on the display as a first size, and
display second image on the display as a second size larger than the first size in response to receiving operation to the first notification information.
